(19) United States
(12) Patent Application Publication
(10) Pub. No.: US 2013/0117085 A1
(43) Pub. Date: May 9, 2013

(54) DISTRIBUTED INCENTIVE DISTRIBUTION AND REDEMPTION

(71) Applicants: Roberto Aiello, Bend, OR (US); Amber Brown, Sierra Madre, CA (US); Joseph Marks, Watertown, MA (US)

(72) Inventors: Roberto Aiello, Bend, OR (US); Amber Brown, Sierra Madre, CA (US); Joseph Marks, Watertown, MA (US)

(73) Assignee: DISNEY ENTERPRISES, INC., Burbank, CA (US)

(21) Appl. No.: 13/288,627

(22) Filed: Nov. 3, 2011

(51) Int. Cl. G06Q 30/02

(52) U.S. Cl. 705/14.25; 705/14.1; 705/14.38

(57) ABSTRACT

A community of members with a set of global goals and a set of individual member goals is established. The community of members provides a set of services. Further, an analysis is performed on one or more attributes of a first plurality of customers. In addition, a set of incentives is provided to at least one a second plurality of customers to interact with at least a subset of the community of members based upon the analysis to maximize the set of global goals and the set of individual member goals.

### BACKGROUND

1. Field

This disclosure generally relates to the field of incentives. More particularly, the disclosure relates to an incentive distribution system.

2. General Background

Current incentive distribution systems take the form of single-product incentives that can be redeemed at any retailer or single-retailer incentives that are redeemed at a single retailer, but may apply to a variety of products/services at that retailer. Some current systems extend the single-retailer-type incentives to provide point-of-sale (“POS”) incentives based on past/current purchases, but do not change the single-retailer functionality. Current online incentive systems are basically single-retailer type incentive programs that differentiate themselves by providing short-term and high-discount incentives that are distributed electronically to a geographically relevant audience. These current online incentive systems represent multiple retailers in a single geographic area, but the incentives offered on any particular day are entirely independent of each other.

These existing systems are less than optimal for retailers that operate multiple locations in a single geographic area. Similarly, with respect to multiple independent retailers in a single geographic area such as a shopping mall or a shopping district, the current systems benefit only single retailers and do not attempt to create any global benefit to the community of retailers. For example, a shopping mall may have several stores that sell a particular product. A current online incentive system may provide an incentive to a single store. Although the incentive may be successful in driving business to that retailer, at some point the incentive may have too many takers for the single retailer, which may result in unsatisfied customers. The retailer may be better off from a customer satisfaction standpoint if the incentive-holding customers were serviced by another location of the same retailer, serviced by another vendor in the same geographical area, or were provided with an alternative incentive to a non-competing business.

Further, current redemption methods for incentives are inadequate for emerging applications such as mobile coupons and other types of online incentives. Current methods of offline redemption include a coupon without a redemption code. In particular, a coupon without a redemption code is considered a rebate. Rebates are typically redeemed by mail. The merchant prints a receipt that the customer has to mail in order to receive a check or a credit. Further, other current methods of offline redemption include a coupon with a redemption code. A coupon with a redemption code results in a lower price for the item. The merchant validates the coupon with the code at the POS. In addition, current methods of real-time redemption include hardware configurations that include machines at the POS locations. When the user scans a mobile coupon, the machine connects to a central database to validate the coupon. The machine can print a ticket called a “clearing coupon” as physical proof for the merchant, which may also be utilized for multiple-point redemptions. Other current methods of real-time redemption include software configurations. The software configurations allow a coupon to trigger the purchase of digital goods.

In addition, a variety of clearing methodologies are currently utilized for redemption. The clearing methodologies include manual clearing in which the merchant delivers the printed coupons to be cleared by a specialized clearinghouse. Other clearing methodologies include automatic clearing such that the clearing is performed without a clearing coupon. For example, real-time redemptions by software or the purchase of digital goods may utilize automatic clearing.

The current redemption and clearing methods for incentives involve integration with the POS. However, integration with the POS is simply not practical for emerging applications such as mobile coupons and other types of online incentives.

### SUMMARY

In one aspect of the disclosure, a process is provided. The process establishes a community of members with a set of global goals and a set of individual member goals. The community of members provides a set of services. Further, the process performs an analysis on one or more attributes of a first plurality of customers. In addition, the process provides a set of incentives to at least one of a second plurality of customers to interact with at least a subset of the community of members based upon the analysis to maximize the set of global goals and the set of individual member goals.

In another aspect of the disclosure, a system is provided. The system includes a community establishment module that establishes a community of members with a set of global goals and a set of individual member goals. The community of members provides a set of services. Further, the system includes a community database that stores data corresponding to the community of members. In addition, the system includes a customer database that stores customer data. Further, the system includes a processor that performs an analysis on one or more attributes of a first plurality of customers. The system also includes an incentive distribution module that provides a set of incentives to at least one of a second plurality of customers to interact with at least a subset of the community of members based upon the analysis to maximize the set of global goals and the set of individual member goals.

In yet another aspect of the disclosure, a computer program product is provided. The computer program product includes a computer-useable medium having a computer-readable program. The computer-readable program when executed on a computer causes the computer to establish a community of members with a set of global goals and a set of individual member goals. The community of members provides a set of services. Further, the computer-readable program when executed on the computer causes the computer to perform an analysis on one or more attributes of a first plurality of customers. In addition, the computer-readable program when executed on the computer causes the computer to provide a set of incentives to at least one of a second plurality of customers to interact with at least a subset of the community of members based upon the analysis to maximize the set of global goals and the set of individual member goals.

In another aspect of the disclosure, a process is provided. The process receives, through a network, an indicium of an incentive from a customer at a point of sale location. The incentive is a rebate. Further, the process provides, through the network, the incentive to the customer.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a community incentive distribution configuration.

FIG. 2 illustrates a community incentive management system.

FIG. 3 illustrates a process that may be utilized to provide community incentive distribution.

FIG. 4 illustrates a process that provides an incentive to a customer.

FIG. 5 illustrates a block diagram of a station or system that provides an incentive.

### DETAILED DESCRIPTION

A community incentive distribution system is provided that not only accounts for individual product and individual retailer needs, but also incentivizes behavior that benefits a community, especially a geographically related community, of retailers. The community incentive distribution system may be utilized to provide distribution of incentives by modifying the incentive based on maximizing an index of global satisfaction amongst a community of retailers and/or a plurality of consumers utilizing that community of retailers. The modification of the incentive may be effectuated by modifying the value, product, retailer, timing, or other feature of the incentive. The incentive distribution system balances the desires of individual vendors to attract customers with an overall global objective of maximizing one or more global parameters such as global revenue, global customer satisfaction, global traffic flow, reducing resource consumption, and/or the like. In one embodiment, a plurality of individual retailers may be utilized to define a particular incentive campaign. A community of members has a set of global goals and a set of individual goals. As an example, a community may be a set of the individual retailers that have some common interests. Alternatively or in addition, the community may be represented by a separate entity that operates a marketplace in which the set of individual retailers operate. In this configuration, the common interests are represented by marketplace interests that are distinct from the individual retailer interests. The common interests are parameterized and utilized to modify at least one implementation feature of the particular incentive campaign.

The community incentive distribution system may be utilized with a variety of different communities such as communities that are located geographically next to one another. For example, a theme park has many co-owned retailers that compete with each other for business, but global satisfaction is a goal that is at least as important as the success of any individual retailer. Other possible communities include shopping malls, shopping districts, or the like. Further, the community incentive distribution system may be utilized with communities that are not located geographically next to one another.

Various types of incentives may be utilized by the community incentive distribution system. As an example, a coupon may be utilized. As another example, a rebate may be utilized. Other incentives may be alternatively or additionally utilized.

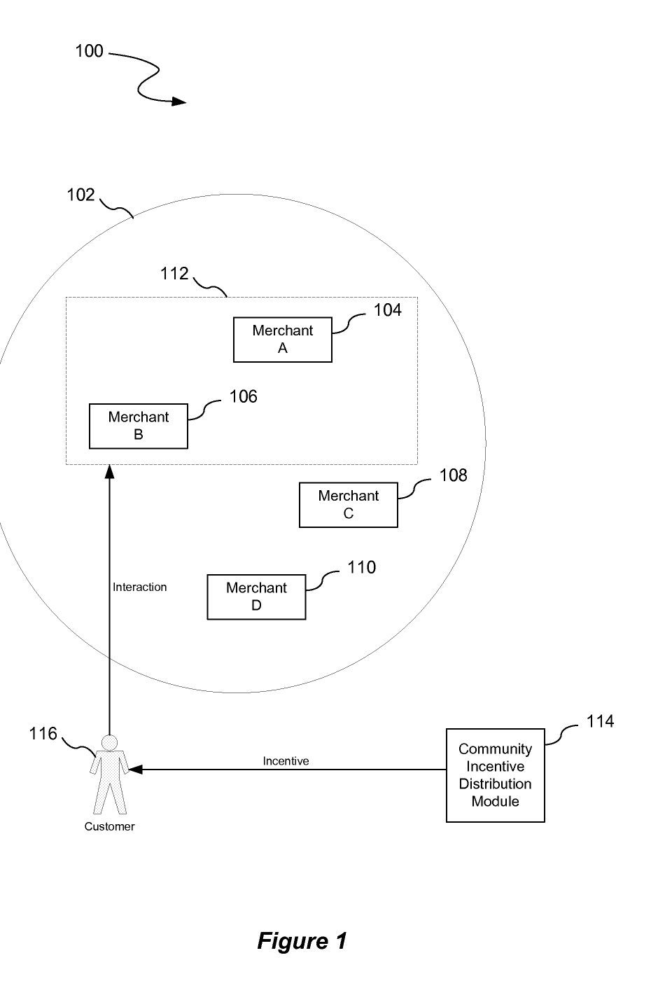

FIG. 1 illustrates a community incentive distribution configuration 100. The community incentive distribution configuration 100 includes a community 102. As an example, the community 102 has members such as a merchant A 104, a merchant B 106, a merchant C 108, and a merchant D 110. Merchants are merely utilized as examples. Members may alternatively or additionally be service providers, retailers, and/or the like. The set of members may provide services to customers. The term services is intended herein to include sale of products, performance of activities, and/or the like. A community incentive distribution module 114 may be utilized to distribute one or more incentives to a customer 116. The incentives are intended to incentivize the customer 116 to interact with at least a subset 112 of the community 102. For example, the subset may include the merchant A 104 and the merchant B 106.

The community 102 is established based on a set of global goals and a set of individual member goals. As an example, a global goal may be crowd management. For instance, the community 102 may be a group of restaurants located next to one another in a theme park. The community 102 has the global goal of reducing wait times to provide customer satisfaction for all of the restaurants in the community 102. However, each of the restaurants in the community 102 has an individual goal of filling to capacity at any given time to maximize revenue. For instance, if at a given time, the merchant C 108 and the merchant D 110 are filled to capacity, the community incentive distribution module 114 may provide an incentive to the customer 116 to go to at least one merchant from the subset 112, i.e., the merchant A 104 or the merchant B 106, which may not be filled to capacity. Accordingly, this community-driven optimization approach balances the individual benefits of each member of the community 102 with the global goal of the community 102 as a whole.

Various global goals may be utilized. Examples of global goals include, but are not limited to, crowd management, increasing brand reputation, increasing a collective customer experience for a plurality of customers, increasing the overall revenue for the community 102, increasing the overall profit for the community 102, and maximizing the entire spending of the customer throughout the community 102.

Further, various individual member goals may be utilized. Examples of individual member goals include, but are not limited to, increasing brand reputation, increasing collective customer experience, increasing revenue, increasing profitability, increasing customer throughput, and decreasing customer wait times.

The community incentive distribution module 114 manages incentives at a community level. In other words, each individual member of the community 102 does not have to be concerned with managing incentives. A centralized system may be utilized to manage the incentives for the community 102 as a whole.

The customer 116 is illustrated for illustrative purposes. A plurality of customers may be provided with the same or different incentives to interact with the same or different portions or entireties of the community 102.

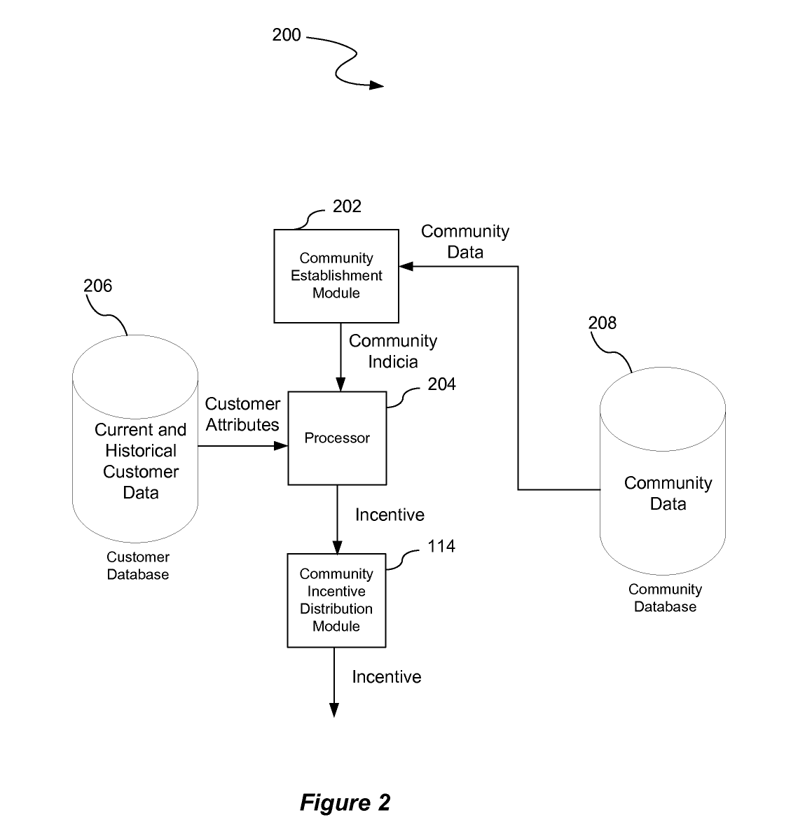

FIG. 2 illustrates a community incentive management system 200. The community incentive management system 200 determines what incentives are provided and to which customers those incentives are provided. The community incentive management system 200 includes a community establishment module 202 that receives community data from a community database 208. The community data indicates information associated with each of the individual members and the overall goals of the community. Accordingly, the community establishment module 202 establishes a community based on the community data. After the community is established, the community establishment module may provide community indicia regarding the community to a processor 204. The community indicia may include information such as names of the members, individual goals of the members, geographic locations of the members, community global goals, and/or the like. The processor 204 may also receive one or more customer attributes of a first plurality of customers from a customer database 206, some of which may be derived from one or more interactions between the first plurality of customers and the community of members. The processor 204 may then perform a real-time analysis and/or a historical analysis on the attributes.

In one embodiment, the customer database 206 contains current location data for at least a subset of the plurality of customers with respect to at least a subset of the community of members, and the real-time analysis of the customer attributes is based on that location data. As an example, the location data may be based on geolocation and geotracking data. The geolocation and geotracking data may be obtained through a wireless network such as Wi-Fi or GPS. For instance, a customer may have a device such as a smartphone, cell phone, tablet, laptop, personal digital assistant (“PDA”), or the like that has a tracker which provides the geolocation and geotracking data to the processor 204. In another embodiment, the customer database 206 contains current sales data for at least a subset of the plurality of customers received from at least a subset of the community of members, and the real-time analysis of the customer attributes is based on that sales data. In yet another embodiment, the customer database 206 contains a plurality of user profiles corresponding to the plurality of customers and the real-time analysis of the customer attributes is based on that plurality of user profiles. Various devices or sources of information may be utilized to input any of the foregoing information to the processor 204. Further, networks other than wireless networks may be utilized for the delivery and receipt of data.

In one embodiment, the customer database 206 may contain historical location data of the plurality of customers with respect to at least a subset of the community of members, and the historical analysis of the customer attributes is based on that historical location data. As an example, the historical location data may be based on geolocation and geotracking data. The geolocation and geotracking data may be obtained through a wireless network such as Wi-Fi or GPS. For instance, a customer may have a device such as a smartphone, cell phone, tablet, laptop, PDA, or the like that has a tracker which previously provided the geolocation and geotracking data stored in the customer database 206. In another embodiment, the customer database 206 contains historical sales data for at least a subset of the plurality of customers received from at least a subset of the community of members, and the historical analysis of the customer attributes is based on that historical sales. Various devices or sources of information may be utilized to provide any of the foregoing information stored in the customer database 206. Further, networks other than wireless networks may be utilized for the delivery and receipt of data.

By utilizing real-time analysis and/or historical analysis of the customer attributes, the processor 204 may learn over time how to optimize the global goals and the individual member goals. The processor 204 may then determine the incentive and with which subset or set of members the incentive should be associated. The processor 204 may then provide the incentive to the community incentive distribution module 114 for distribution to a plurality of customers, which may be distinct from the plurality of customers used to provide the customer attributes for the real-time and/or historical analysis of the customer attributes.

In one embodiment, the set of individual member goals includes a minimum number of customers visiting each member's establishment. The global goal is to minimize the sum of all the incentives needed to entice the desired minimum number of customers into each establishment, while sending at most one incentive to each customer. Based on the customer attributes derived from historical interaction data regarding the magnitude of incentives needed to entice customers at different distances from individual member establishments to visit those establishments, and based on current location data, the magnitude of incentive needed to entice a customer to go a particular member establishment can be estimated. Specifically, let i(c,m) be an integer variable from the set {0,1} that corresponds to sending an incentive to each customer c of C total customers to visit each establishment m of M total establishments. A value of 1 indicates that an incentive will be given, and a value of 0 indicates that no incentive will be given. Let f(c,m) be the function that estimates the magnitude of the incentive needed to entice customer c to visit establishment m. The requirement that each customer c be given no more than one incentive is specified as a set of C inequalities:

$${\sum }_{m = 1}^{m = M} i ( c , m ) \leq 1$$

The individual member goals of having a minimum number n(m) of customers visiting each establishment m are specified as another set of M inequalities:

$${\sum }_{c = 1}^{c = C} i ( c , m ) \geq n ( m )$$

And the global goal of minimizing the sum of all the incentives offered is captured by minimizing the objective function:

$${\sum }_{c = 1 , m = 1}^{c = C , m = M} f ( c , m ) \cdot i ( c , m )$$

For example, the processor 204 can minimize this objective function while satisfying the inequalities using an integer linear programming configuration. Further, other ways of formulating individual member's goals and global goals as optimization problems, and different configurations for finding solutions to these problems, can be computed by the processor 204.

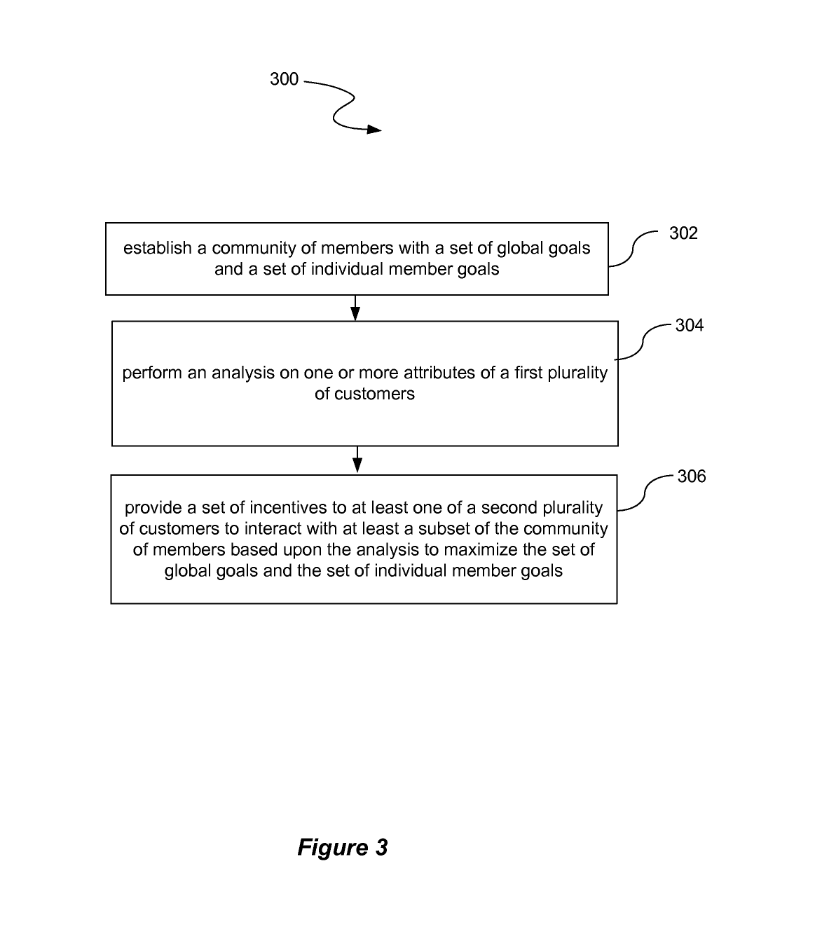

FIG. 3 illustrates a process 300 that may be utilized to provide community incentive distribution. At a process block 302, the process 300 establishes a community of members with a set of global goals and a set of individual member goals. The community of members provides a set of services to a plurality of customers. Further, at a process block 304, the process 300 performs an analysis on one or more attributes of a first plurality of customers. In one embodiment, at least a portion of the one or more attributes may be derived from one or more interactions between the first plurality of customers and the community of members. In another embodiment, none of the one or more attributes may be derived from one or more interactions between the first plurality of customers and the community of members. In addition, at a process block 306, the process 300 provides a set of incentives to at least one of a second plurality of customers to interact with at least a subset of the community of members based upon the analysis to maximize the set of global goals and the set of individual member goals.

In another embodiment, a configuration may be utilized to provide an incentive to a customer without the incentive having to be provided at the POS location. The customer may directly send an indicium of the incentive to a system while the customer is at the POS location. As an example, a customer may purchase a product and take a picture of his or her receipt with his or her smartphone. The customer may then send his or her incentive directly to a system, e.g., a clearinghouse system, to obtain the incentive in real-time at the POS. The clearinghouse may then provide a credit to a credit card of the customer, provide a set of future redemption points, or the like. As an example, the user may receive redemption points at the POS after the purchase and then immediately utilize those redemption points at the POS. In one embodiment, the incentive may be for a member or a subset of members in a community. Accordingly, the customer may purchase an item at a POS and then receive an incentive to purchase a product at another POS in the community, which may help maximize the global goals and individual member goals of the community.

In one embodiment, a set of code is provided to a device utilized by the customer so that the customer may provide proof of purchase to a clearinghouse or other entity to obtain the incentive. For example, an application may be downloaded by the user to a smartphone of the user. Alternatively, the application may be locally installed on the smartphone. The application may then automatically assist the user with communicating the proof of purchase to obtain the incentive.

As a result, mobile devices may be utilized to obtain incentives. Further, the POS locations do not have to perform any additional expenditures to upgrade equipment as integration between the POS locations and the mobile devices is unnecessary in this configuration.

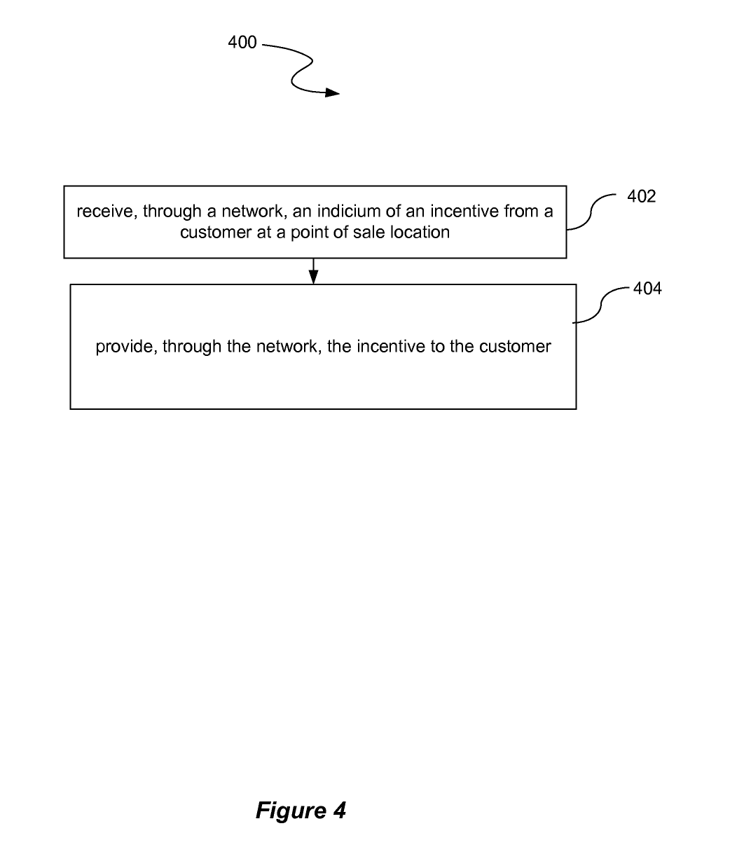

FIG. 4 illustrates a process 400 that provides an incentive to a customer. At a process block 402, the process 400 receives, through a network, an indicium of an incentive from a customer at a point of sale location. The incentive is a rebate. Further, at a process block 404, the process 400 provides, through the network, the incentive to the customer.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above. For example, a computer may be a personal computer, laptop, smartphone, cell phone, tablet, laptop, PDA, kiosk, set-top box (“STB”), or the like.

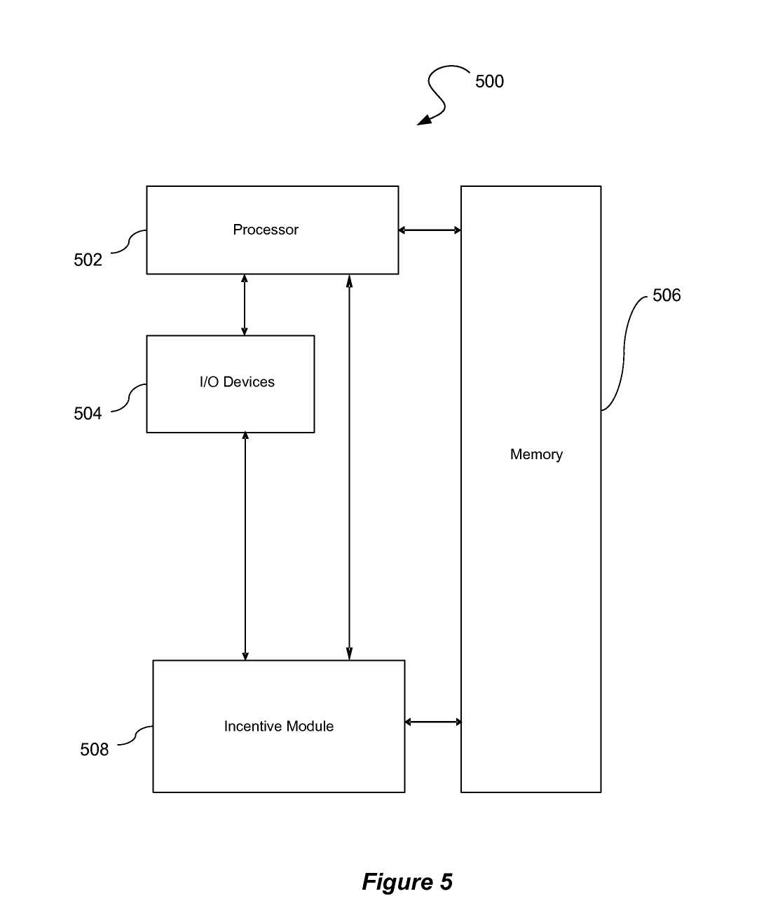

FIG. 5 illustrates a block diagram of a station or system 500 that provides an incentive. In one embodiment, the station or system 500 is implemented utilizing a general purpose computer or any other hardware equivalents. Thus, the station or system 500 comprises a processor 502, a memory 506, e.g., random access memory (“RAM”) and/or read only memory (ROM), an incentive module 508, and various input/output devices 504, (e.g., audio/video outputs and audio/video inputs, storage devices, including but not limited to, a tape drive, a floppy drive, a hard disk drive, a compact disk drive, or solid-state memory, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the incentive module 508 may be implemented as one or more physical devices that are coupled to the processor 502. For example, the incentive module 508 may include a plurality of modules. Alternatively, the incentive module 508 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 506 of the computer. As such, the incentive module 508 (including associated data structures) of the present disclosure may be stored on a computer readable medium, e.g., RAM memory, magnetic or optical drive or diskette and the like. The station or system 500 may be utilized to implement any of the configurations herein.

It is understood that the apparatuses, systems, computer program products, and processes described herein may also be applied in other types of apparatuses, systems, computer program products, and processes. Those skilled in the art will appreciate that the various adaptations and modifications of the embodiments of the apparatuses, systems, computer program products, and processes described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. A method comprising:
establishing a community of members with a set of global goals and a set of individual member goals, the community of members providing a set of services;
performing an analysis on one or more attributes of a first plurality of customers; and
providing a set of incentives to at least one of a second plurality of customers to interact with at least a subset of the community of members based upon the analysis to maximize the set of global goals and the set of individual member goals.

2. The method of claim 1, wherein at least a portion of the one or more attributes is derived from one or more interactions between the first plurality of customers and the community of members.

3. The method of claim 1, wherein the set of incentives includes at least one coupon corresponding to a future interaction with at least a subset of the community of members.

4. The method of claim 1, wherein the analysis on the one or more attributes of the first plurality of customers is a real time analysis.

5. The method of claim 1, wherein the analysis on the one or more attributes of the first plurality of customers is a historical analysis.

6. The method of claim 5, wherein the one or more attributes are based on a plurality of user profiles corresponding to the plurality of customers.

7. The method of claim 6, wherein the historical analysis is based on one or more interactions between the first plurality of customers and at least a subset of the community of members.

8. The method of claim 7, wherein the one or more interactions between the first plurality of customers and at least the subset of the community of members are sales interactions.

9. The method of claim 1, wherein the set of individual member goals is a set of minimum numbers of customers.

10. The method of claim 1, wherein the set of individual member goals is a set of maximum numbers of customers.

11. The method of claim 1, wherein the set of individual member goals includes increasing individual member revenue.

12. The method of claim 1, wherein the set of individual member goals includes increasing individual member profit.

13. The method of claim 1, wherein the set of individual member goals includes decreasing customer wait times.

14. The method of claim 1, wherein the set of global goals includes crowd flow management.

15. The method of claim 1, wherein the set of global goals includes increasing overall brand reputation of the community of members.

16. The method of claim 1, wherein the set of global goals includes increasing collective customer experience.

17. The method of claim 1, wherein the set of global goals includes increasing overall revenue of the community of members.

18. The method of claim 1, wherein the set of global goals includes increasing overall profit of the community of members.

19. The method of claim 1, wherein the set of incentives provided to at least one of the second plurality of customers to interact with at least a subset of the community of members to maximize the set of global goals and the set of individual member goals is computed using an optimization procedure.

20. The method of claim 19, wherein the optimization procedure is linear programming.

21. The method of claim 1, further comprising storing data corresponding to the community of members in a community database.

22. The method of claim 1, wherein the community of members includes at least one service provider.

23. The method of claim 1, wherein the community of members includes at least one retailer.

24. The method of claim 1, wherein the community of members includes at least one entertainment provider.

25. A system comprising:
a community establishment module that establishes a community of members with a set of global goals and a set of individual member goals, the community of members providing a set of services;
a community database that stores data corresponding to the community of members;
a customer database that stores customer data;
a processor that performs an analysis on one or more attributes of a first plurality of customers; and
an incentive distribution module that provides a set of incentives to at least one of a second plurality of customers to interact with at least a subset of the community of members based upon the analysis to maximize the set of global goals and the set of individual member goals.

26. The system of claim 26, wherein at least a portion of the one or more attributes is derived from one or more interactions between the first plurality of customers and the community of members.

27. A computer program product comprising a computer useable medium having a computer readable program, wherein the computer readable program when executed on a computer causes the computer to:
establish a community of members with a set of global goals and a set of individual member goals, the community of members providing a set of services;
perform an analysis on one or more attributes of a first plurality of customers; and
provide a set of incentives to at least one of the a second plurality of customers to interact with at least a subset of the community of members based upon said analysis to maximize the set of global goals and the set of individual member goals.

28. The computer program product of claim 27, wherein at least a portion of the one or more attributes is derived from one or more interactions between the first plurality of customers and the community of members.

29. A method comprising:
receiving, through a network, an indicium of an incentive from a customer at a point of sale location, the incentive being a rebate; and
providing, through the network, the incentive to the customer.

30. The method of claim 29, wherein the incentive is a coupon.

31. The method of claim 29, wherein the point of sale location is part of a community of members.

32. The method of claim 29, wherein the indicium is a picture of a receipt, the receipt being received by the customer from the point of sale location.

33. The method of claim 32, wherein the picture of the receipt is generated by a photographic device.

34. The method of claim 29, further comprising providing a set of code to a communication device utilized by the customer.

35. The method of claim 34, wherein the set of code sends the indicium to a clearinghouse that provides the incentive to the customer.

36. The method of claim 35, wherein the clearinghouse provides the incentive to the customer by providing a credit to a credit card utilized by the customer at the point of sale location.

37. The method of claim 35, wherein the clearinghouse provides the incentive to the customer by providing a set of future redemptions points at the point of sale location or at a different point of sale location to the customer.
